(19) United States
(12) Patent Application Publication
(10) Pub. No.: US 2025/0171592 A1
(43) Pub. Date: May 29, 2025

(54) SILICONE MODIFIED POLYOL AND APPLICATIONS THEREOF

(71) Applicant: MOMENTIVE PERFORMANCE MATERIALS INC., Niskayuna, NY (US)

(72) Inventors: Vinu Krishnan Appukuttan, Bangalore (IN); Debdeep Maity, Purba Medinipur (IN); Yogesh Tiwary, Bangalore (IN)

(21) Appl. No.: 18/958,292

(22) Filed: Nov. 25, 2024

Related U.S. Application Data
(60) Provisional application No. 63/603,390, filed on Nov. 28, 2023.

(51) Int. Cl. C08G 77/04; C08G 77/00; C08G 77/448; C08J 3/05

(52) U.S. Cl. CPC C08G 77/045; C08G 77/448; C08G 77/70; C08J 3/05; C08J 2383/12

(57) ABSTRACT

A silicone modified organic polymer is shown and described herein. The silicone modified organic polymer is a reaction product of a composition comprising an organic polyol, a silicone resin, and a hydrophilic silane. The hydrophilic silicone modified resin is directly dispersible in water. An aqueous dispersion of the silicone modified organic polymer is suitable for use as an additive in a coating composition.

### CROSS-REFERENCE TO RELATED APPLICATIONS

This application claims priority to and the benefit of U.S. Provisional Application No. 63/603,390, titled “SILICONE MODIFIED POLYOL AND APPLICATIONS THEREOF,” filed on Nov. 28, 2023, the disclosure of which is incorporated herein by reference in its entirety.

### FIELD OF INVENTION

The present invention relates to a silicone modified polymer. In particular, the present invention relates to a silicone modified organic polymer. The silicone modified organic polymer is the reaction product of a polyol, a silicone resin, and a hydrophilic silane. The silicone modified organic polymer may be used to form a water borne dispersion suitable for use in coating compositions.

### BACKGROUND

Silicone modified polyesters are used in a variety of coating applications including, for example, cookware, coil coatings, and the like. These resins tend to have relatively high viscosities, and solvents are employed to dilute the resins to make them more useful in coating processes. The solvents typically employed to dilute these resins are volatile organic compounds (VOCs). The current trend in many industries is to reduce or eliminate the volatile organic compounds used in producing a product. One way to remove the volatile organic solvents is through emulsification. For these types of materials, however, the emulsification process can be complex, adding to the time and cost for producing these materials.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a silicone modified organic polymer. The silicone modified organic polymers are the reaction product of an organic polyol, a silicone resin, and a hydrophilic silane.

The silicone modified organic polymers are water dispersible and may be dispersed directly into water. This can be accomplished without the need for emulsification. Optionally, a dispersion of the silicone modified organic polymer can be emulsified, which may be useful for applications of the silicone modified organic polymer as an additive in a coating composition.

Also provided is a coating composition comprising a dispersion or emulsion of the silicone modified organic polymer.

In one aspect, provided is a silicone modified organic polymer comprising a reaction product of: an organic polyol; a silicone resin; and a hydrophilic silane or an oligomer thereof; wherein the silicone resin is an organopolysiloxane of the formula:

MDTQ
where
M is R¹R²R³SiO^{1/2}
D is R⁴R⁵SiO_{2/2}
T is R⁶SiO_{3/2};
Q is SiO_{4/2}; and
   where R¹, R², R³, R⁴, R⁵, and R⁶ are independently selected from a monovalent hydrocarbon radical, OR⁷ or a divalent hydrocarbon radical, OR⁸O, where R⁷ is independently selected from H or a C1-C10 hydrocarbon radical and R⁸ is independently selected from C1-C10 divalent hydrocarbon radical.

In one embodiment, the hydrophilic silane is of the formula:

R⁹—Si(R¹⁰)_{f}(OR¹¹)_{3-f};

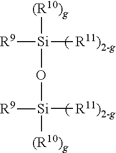

or a mixture thereof;
where R⁹ is a hydrophilic group, and R¹⁰ and R¹¹ are independently selected from a C1-C10 hydrocarbon; f is 0, 1, 2, or 3; and g is 0, 1, or 2.

In one embodiment, R⁹ is selected from a polyalkylene glycol group, a sulfonate group, a phosphonate group, a carboxylate group, a carbohydrate group, a sugar group, and a quaternary amine group.

In one embodiment, R⁹ is a polyalkylene group of the formula: —R¹²—[O—R¹³-]_{g}OR¹⁴ where R¹² is a C2-C10 hydrocarbon; R¹³ is a C2-C10 hydrocarbon; R¹⁴ is H or a C1-C10 hydrocarbon; and g is 1-20.
the hydrophilic group is a quaternary amine group of the formula:

—N⁺(R¹⁵)(R¹⁶)(R¹⁷)

where R¹⁵, R¹⁶, and R¹⁷ are each independently selected from n alkyl (C1-C22), aryl, or a combination of chemical groups forming a ring structure and up to 2 of R¹⁵, R¹⁶, and R¹⁷ may be H.

In one embodiment, the silicone resin comprises a OR⁷ group and/or an OR⁸⁰ in an amount of from about 0.1 wt. % to about 50 wt. %, based on the weight of the polyorganosiloxane.

In one embodiment, the silicone resin is a DT type resin comprising from about 0.5 wt. % to about 70 wt. % of the D unit, and from about 30 wt. % to about 99.5 wt. % of a T unit based on the total weight of the silicone resin.

In one embodiment, the organic polyol is selected from the group consisting of a polyester polyol, a polyether polyol, a polyurethane polyol, a poly(urea)urethane polyol, a polyacrylate polyol, a polycarbonate polyol, and a polyamide polyol.

In one embodiment, the organic polyol is a polyester polyol.

In one embodiment, the organic polyol has a OH value of from about 3 to about 400 KOH/g

In one embodiment, the organic polyol is present in the composition in an amount of from about 3 wt. % to about 95 wt. % based on the weight of the composition.

In one embodiment, the silicone resin is present in the composition in an amount of from about 3 wt. % to about 60 wt. % based on the weight of the composition.

In one embodiment, the hydrophilic silane is present in the composition in an amount of from about 1 wt. % to about 40 wt. % based on the weight of the composition.

In one embodiment, the silicone modified organic polymer is hydrophilic.

In another aspect, provided is an aqueous dispersion comprising the silicone modified organic polymer of any of the previous embodiments.

In one embodiment, the aqueous dispersion has an average particle size of from about 0.1 micron to about 50 micron.

In one embodiment, the aqueous dispersion comprises a surfactant

In one embodiment, the aqueous dispersion comprises a base.

In another aspect, provided is a coating composition comprising the aqueous dispersion of any of the previous embodiments.

In still another aspect, provided is a paint comprising the coating composition of any of the previous embodiments.

In yet another aspect, provided is a process for preparing an silicone modified organic polymer of any of the previous embodiments comprising reacting a mixture of the organic polyol, the silicone resin, and the hydrophilic silane in the presence of a catalyst.

In one embodiment, the reaction is conducted at a temperature of from about 40° C. to about 170° C.

In a further aspect, provided is a process for forming an aqueous dispersion comprising mixing the silicone modified organic polymer of any of the previous embodiments in water.

The following description discloses various illustrative aspects. Some improvements and novel aspects may be expressly identified, while others may be apparent from the description and drawings.

### DETAILED DESCRIPTION

Reference will now be made to exemplary embodiments, examples of which are illustrated in the various aspects, embodiments, and examples. It is to be understood that other embodiments may be utilized, and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Provided is a silicone modified organic polymer. The silicone modified organic polymer is the reaction product of a polyol, a silicone resin, and a hydrophilic silane. The silicone modified organic polymers are water-dispersible, and may be directly dispersed in water, to provide an aqueous dispersion.

The polyol is selected from an organic polyol. The organic polyol is not particularly limited and can be selected as desired for a particular purpose or intended application. The organic polyol may be selected from an organic polymer having two or more hydroxyl groups. Examples of suitable organic polyols include, but are not limited to, a polyester polyol, a polyether polyol, a polyurethane polyol, a poly(urea)urethane polyol, a polyacrylate polyol, a polycarbonate polyol, a polyamide polyol, and the like.

Examples of polyester polyols include, but are not limited to, polyester glycols, polycaprolactone polyols, polycarbonate polyols, and mixtures of two or more thereof. Polyester glycols can include the esterification products of one or more dicarboxylic acids having from four to ten carbon atoms, such as but not limited to adipic, succinic or sebacic acids, with one or more low molecular weight glycols having from two to ten carbon atoms, such as but not limited to ethylene glycol, propylene glycol, diethylene glycol, 1,4-butanediol, neopentyl glycol, 1,6-hexanediol and 1,10-decanediol. Esterification procedures for producing polyester polyols are known in the art.

Examples of polycaprolactone polyols include, but are not limited to, those prepared by condensing caprolactone in the presence of difunctional active hydrogen material such as water or low molecular weight glycols, for example ethylene glycol and propylene glycol. Non-limiting examples of suitable polycaprolactone polyols can include commercially available materials designated as the CAPA® series from Solvay Chemical of Houston, Tex., the TONE™ series from Dow Chemical of Midland, Mich. such as TONE 0201, 0210, 0230 & 0241, the polyester from KCC corporation, and the Eterkyd polyester grades from Eternal Materials such as Eterkyd 5054-PR-40, Eterkyd 5055-R-55-2, Eterkyd 50552-R-70, Eterkyd 50682-R-60, Eterkyd 5055-R-65-3 and Eterkyd 50558-R-70.

Examples of polycarbonate polyols include, but are not limited to, aliphatic polycarbonate diols, for example those based upon alkylene glycols, ether glycols, alicyclic glycols or mixtures thereof. In some embodiments, the alkylene groups for preparing the polycarbonate polyol can comprise from 5 to 10 carbon atoms and can be straight chain, cycloalkylene or combinations thereof. Non-limiting examples of such alkylene groups include hexylene, octylene, decylene, cyclohexylene, cyclohexyldimethylene, and the like. Suitable polycarbonate polyols can be prepared, in one embodiment, by reacting a hydroxy terminated alkylene glycol with a dialkyl carbonate, such as methyl, ethyl, n-propyl, n-butyl carbonate, and the like, and/or or diaryl carbonate, such as diphenyl or dinaphthyl carbonate, or by reacting of a hydroxy-terminated alkylene diol with phosgene or bischoloroformate. Non-limiting examples of such polycarbonate polyols include those commercially available as Ravecarb™ 107 from Caffaro Industrie SpA, DESMOPHEN® (commercially available from Covestro), and ETERNACOLL® polycarbonate diols from UBE Corporation such as PH-50, Ph-100, PH-200, UH-50, UH-200, UH-300.

Polycarbonate polyols can be produced by reacting a diol, such as described herein, and a dialkyl carbonate, such as described in U.S. Pat. No. 4,160,853, which is incorporated herein by reference in its entirety. The polycarbonate polyol can include polyhexamethylene carbonate such as, for example, HO—(CH₂)₆—[O—C(O)—O—(CH₂)₆]ₙ—OH, wherein n is an integer from 4 to 24, or from 4 to 10, or from 5 to 7.

Polycarbonate polyols can also be formed by methods as disclosed, for example, in U.S. Pat. Nos. 5,143,997 and 5,527,879, each of which is incorporated by reference herein. For example, polycarbonates may be obtained from the reaction of alcohols or phenols with phosgene or from the transesterification of alcohols or phenols with dialkyl or diaryl carbonates. Polycarbonate functional polyols may be used that have been prepared by the reaction of a diol such as 1,6-hexanediol, C2 (ethylene glycol) to C36 diols such as neopentylglycol, butanediol, 1,10-decanediol, butylethyl propanediol, 2-ethyl-1,3-hexanediol, cyclohexanedimethanol, 2,2,4-trimethylpentane-1,3-diol, Esterdiol 204, and/or polytetrahydrofuran, with either phosgene or dimethylcarbonate.

Examples of polyether polyols include, but are not limited to, poly(oxyalkylene) polyols or polyalkoxylated polyols. Poly(oxyalkylene) polyols can be prepared in accordance with known methods. In a non-limiting embodiment, a poly(oxyalkylene) polyol can be prepared by condensing an alkylene oxide, or a mixture of alkylene oxides, using acid- or base-catalyzed addition with a polyhydric initiator or a mixture of polyhydric initiators, such as ethylene glycol, propylene glycol, glycerol, and sorbitol. Compatible mixtures of polyether polyols can also be used. As used herein, “compatible” means that two or more materials are mutually soluble in each other so as to essentially form a single phase. Examples of alkylene oxides can include, but are not limited to, ethylene oxide, propylene oxide, butylene oxide, amylene oxide, aralkylene oxides, such as styrene oxide, mixtures of ethylene oxide and propylene oxide, and the like. In some non-limiting embodiments, polyoxyalkylene polyols can be prepared with mixtures of alkylene oxide using random or stepwise oxyalkylation. Non-limiting examples of such poly(oxyalkylene) polyols include polyoxyethylene polyols, such as polyethylene glycol, and polyoxypropylene polyols, such as polypropylene glycol.

Other polyether polyols include block polymers such as those having blocks of ethylene oxide-propylene oxide and/or ethylene oxide-butylene oxide. In some non-limiting embodiments, the polyether polyol comprises a block copolymer of the following formula:

HO—(CHR¹⁸CHR¹⁹—O)ₕ—(CHR²⁰CHR²¹—O)ᵢ—(CHR²²CHR²³—O)ⱼ—H
wherein R¹⁸ through R²³ can each independently represent hydrogen or methyl; and h, i, and j can each be independently selected from an integer from 0 to 300, wherein h, i, and j are selected such that the number average molecular weight of the polyol is less than about 32,000 grams/mole, or less than about 10,000 grams/mole, as determined by GPC. In other non-limiting embodiments h, i, and j each can be independently an integer from 1 to 300. In other non-limiting embodiments, R¹⁸, R¹⁹, R²², and R²³ can be hydrogen, and R²⁰ and R²¹ each can be independently selected from hydrogen and methyl, with the proviso that R²⁰ and R²¹ are different from one another. In other non-limiting embodiments, R²⁰ and R²¹ can be hydrogen, and R¹⁸ and R¹⁹ each can be independently selected from hydrogen and methyl, with the proviso that R¹⁸ and R¹⁹ are different from one another, and R²² and R²³ each can be independently selected from hydrogen and methyl, with the proviso that R²² and R²³ are different from one another.

Polyurethane polyols may be prepared by the reaction of a polyisocyanate with excess organic polyol to form a hydroxyl functional polyurethane polymer. Examples of polyisocyanates useful in the preparation of polyurethane polyols include, but are not limited to, toluene-2,4-diisocyanate; toluene-2,6-diisocyanate; diphenylmethane-4,4,-diisocyanate; diphenyl methane-2,4′-diisocyanate; para-phenylene diisocyanate; biphenyl diisocyanate; 3,3′-dimethyl-4,4′-diphenylene diisocyanate; tetramethylene-1,4-diisocyanate; hexamethylene-1,6-diisocyanate; 2,2,4-trimethyl hexane-1,6-diisocyanate; lysine methyl ester diisocyanate; bis(isocyanato ethyl) fumarate; isophorone diisocyanate; ethylene diisocyanate; dodecane-1,12-diisocyanate; cyclobutane-1,3-diisocyanate; cyclohexane-1,3-diisocyanate; cyclohexane-1,4-diisocyanate; methyl cyclohexyl diisocyanate; dicyclohexylmethane diisocyanate; 1-methylcyclohexane-2,4-diisocyanate; 1-methylcyclohexane-2,6-diisocyanate; cyclohexylene-1,3-diisocyanate; cyclohexylene-1,4-diisocyanate; polymethylene polyphenol isocyanates dicyclohexylmethane-2,4′-diisocyanate; dicyclohexylmethane-4,4,-diisocyanate and mixtures thereof. Examples of organic polyols useful in the preparation of urethane polyols include the other polyols described herein, e.g., polyester polyols, polyether polyols, polycarbonate polyols, amide-containing polyols, polyacrylic polyols, polyhydric polyvinyl alcohols, and mixtures of two or more thereof.

Poly(urea) urethane polyols can be prepared by reaction of a polyisocyanate, a polyol, and a polyamine to form a hydroxyl functional poly(urea)urethane polymer. Suitable poly(urea)urethane polyols may also be prepared from an isocyanate functional urea prepolymer with an organic polyol to form a hydroxyl functional poly(urea)urethane polymer. The isocyanate functional urea prepolymer may be formed from the reaction of a polyisocyanate and water. Examples of polyisocyanates and organic polyols useful in the preparation of poly(urea)urethane polyols include the polyisocyanates and polyols described above. The polyamine can be a polyamine having at least two functional groups independently chosen from primary amine (—NH₂), secondary amine (—NH—) and combinations thereof. Examples of suitable polyamines can include but are not limited to aliphatic amines, cycloaliphatic amines, aromatic amines and mixtures thereof.

The size, OH value, acid value, etc. of the polyol can be selected as desired for a particular purpose or intended application. In one embodiment, the polyol has an average molecular weight (Da) of from about 400 to about 50000, from about 1000 to about 20000, or from about 1500 to about 15000. The average molecular weight may be measured via Size Exclusion Chromotography using an Agilent 1100 High-Performance Liquid Chromatograph, commercially available from Agilent Technologies Inc, of Germany, equipped with multiple columns (PLgel Mixed-E from Polymer Laboratories) to ensure sufficient molecular weight resolution. The mobile phase used to transport the analyte through the columns may be tetrahydrofuran at a rate of 1.0 ml/min,

In one embodiment, the polyol can have an OH value of from about 3 KOH/g to about 400 KOH/g, from about 5 KOH/g to about 250 KOH/g, or from about 20 KOH/g to about 160 KOH/g. The OH value is the measurement of the amount of hydroxyl groups present in the polymer and is expressed as mg of KOH/gram of the polymer.

In one embodiment, the polyol has an acid value of from about 0 mgKOH/g to about 30 mgKOH/g, from about 1 mgKOH/g to about 20 mgKOH/g, or from about 1 mgKOH/g to about 15 mgKOH/g. The acid value, or acid number, is the mass of potassium hydroxide (KOH) in milligrams that is required to neutralize one gram of chemical substance, and accordingly, the acid value is a measure of the amount of carboxylic acid groups in a chemical compound. The acid value may be determined using the ASTM D-1639 test method.

The organic polyol may be present in an amount of from about 3 wt. % to about 95 wt. %, from about 5 wt. % to about 90 wt. %, from about 10 wt. % to about 85 wt. %, from about 15 wt. % to about 70 wt. %, from about 20 wt. % to about 50 wt. %, or from about 30 wt. % to about 40 wt. % based on the total weight of the composition for forming the silicone modified organic polymer.

The composition comprises a silicone resin. The silicone resin comprises an organopolysiloxane resin that can include M, D, T, and Q units as is known and understood in the art. In one embodiment, the silicone resin is of the formula:

MDTQ
where
M is R¹R²R³SiO^{1/2}
D is R⁴R⁵SiO_{2/2}
T is R⁶SiO_{3/2};
Q is SiO_{4/2}; and
where R¹, R², R³, R⁴, R⁵, and R⁶ are independently selected from a monovalent hydrocarbon radical, OR⁷ or a divalent hydrocarbon radical, OR⁸O, where R⁷ is independently selected from H or a C1-C10 hydrocarbon radical and R⁸ is independently selected from C1-C10 divalent hydrocarbon radical. The hydrocarbon radical can be unsubstituted, substituted, linear, branched, cyclic, or acyclic, saturated, or unsaturated. The hydrocarbon radical can be an aliphatic or aromatic hydrocarbon. In one embodiment, R¹, R², R³, R⁴, R⁵, and R⁶ are independently selected from a C1-C30 monovalent hydrocarbon. Examples of suitable hydrocarbon groups include, but are not limited to, methyl, ethyl, n-propyl, isopropyl, n-butyl, isobutyl, sec-butyl, t-butyl, n-pentyl, isopentyl, neopentyl, n-hexyl, n-octyl, isooctyl, n-hexenyl, vinyl, allyl, butenyl, butadienyl, cyclopropyl, cyclobutyl, cyclopentyl, cyclohexyl, cyclohexenyl, phenyl, alkylated phenyl groups, hydroxyl, methoxy, ethoxy, isopropoxy, n-butyloxy, t-butyloxy, isobutyloxy, n-pentoxy, neopentoxy, n-hexoxy, n-heptoxy, n-octoxy, phenoxy, vinyloxy, allyloxy, 2-methoxyethoxy, 2-ethoxyethoxy, 2-aminoethoxy, methylamino, dimethylamino, benzylamino, ethanolamino, and diethanolamino groups. In one embodiment, R¹, R², R³, R⁴, R⁵, and R⁶ are methyl. In one embodiment, R¹, R², R³, R⁴, R⁵, and R⁶ are independently selected from methyl and phenyl. In one embodiment, the silicone resin includes M, D, and/or T units where R¹, R², R³, R⁴, R⁵, and R⁶ are methyl, and in some other embodiments, the silicone resin includes M, D, and/or T units where R¹, R², R³, R⁴, R⁵, and R⁶ are phenyl.

Some examples of classes of polysiloxane backbone structures include the MM, MDM, TD, MT, MDT, MDTQ, MQ, MDQ, and MTQ classes of polysiloxanes, and combinations of two or more thereof. In one embodiment, the organopolysiloxane resin can contain from about 0 to about 50 percent, from about 0 to about 40 percent, or from about 0 to about 25 percent by weight of an M unit; from about 0 to about 90 percent, from about 0 to about 60 percent, or from about 0 to about 40 percent by weight of a D unit; from about 0 to 100 percent, 0 to about 90 percent, 0 to about 75 percent, or 0 to about 50 percent by weight of a T unit; and from about 0 to about 60 percent, 0 to about 50 percent, or 0 to about 25 percent by weight of a Q unit based on the weight of the polyorganosiloxane. In one embodiment, the organopolysiloxane resin can contain from about 0 to about 50 percent, from about 5 to about 40 percent, or from about 10 to about 25 percent by weight of an M unit; from about 0 to about 90 percent, from about 5 to about 60 percent, or from about 10 to about 40 percent by weight of a D unit; from about 0 to 100 percent, 1 to about 90 percent, 5 to about 75 percent, or 10 to about 50 percent by weight of a T unit; and from about 0 to about 60 percent, 1 to about 50 percent, or 5 to about 25 percent by weight of a Q unit based on the weight of the polyorganosiloxane. It will be appreciated that the total weight percent of the respective units in the polyorganosiloxane will add up to 100 percent.

In one embodiment, the polyorganosiloxane resin is a DTQ type resin comprising from about 0.5 to about 60 percent, from about 1 to about 50 percent, or about 5 to about 30 percent by weight of a D unit, and from about 40 to about 99.5 percent, from about 50 to about 95 percent, or from about 60 to about 80 percent by weight of a T unit, and from about 0.1 to about 30 percent, from about 1 to about 25 percent, or from about 5 to about 20 percent by weight of a Q unit based on the total weight of the polyorganosiloxane.

In one embodiment the polyorganosiloxane is a DT type resin. In one embodiment, a DT type resin has from about 0.5 to about 60 percent by weight, about 1 to about 50 percent by weight, or about 5 to about 30 percent by weight of a D unit, and from about 40 to about 99.5 percent, from about 50 to about 95 percent, or from about 60 to about 80 percent by weight of a T unit based on the total weight of the polyorganosiloxane. In one embodiment, the polyorganosiloxane is a DT type resin comprising from about 5 to about 50 percent, about 10 to about 45 percent, or about 15 to about 40 percent by weight of a D unit, and from about 50 to about 95 percent, from about 55 to about 90 percent, or from about 60 to about 85 percent by weight of a T unit based on the total weight of the polyorganosiloxane. In one embodiment, the organopolysiloxane is a DT type resin comprising 5 to 40 percent by weight of a T unit of the formula CH₃SiO_{3/2} units, 0 to 35 percent by weight of a D unit of the formula (CH₃)₂SiO_{2/2} units, 15 to 65 percent by weight of a T unit of the formula (C₆H₅)SiO_{3/2}, and 0 to 50 percent by weight of a D unit of the formula (C₆H₅)SiO_{2/2} units based on the total weight of the polyorganosiloxane, wherein there is present, approximately, 1.0 to 1.8 organic radicals for each silicone atom.

In one embodiment, the silicone resin has a ratio of phenyl groups to methyl groups (Ph/Me) of from about 0/100 to about 100/0, from about 15/85 to about 85/15, or from about 80/20 to about 20/80.

In embodiments, the polyorganosiloxane units optionally contain a condensable group. The condensable group can be selected from OR⁷ group or OR⁸⁰ group and optionally one or more of R¹, R², R³, R⁴, R⁵, and R⁶ is selected from OR⁷ or OR⁸⁰ where R⁷ and R⁸ is as described above. In one embodiment, R⁷ is H. In one embodiment, R⁷ is a C1-C10 monovalent hydrocarbon. In one embodiment, R⁷ is a C1-C10 divalent hydrocarbon. In one embodiment, the polyorganosiloxane comprises from about 0.1 percent to about 50 percent by weight, from about 0.5 percent to about 20 percent, or from about 1 percent to about 7 percent by weight of a condensable group based on the weight of the polyorganosiloxane.

In one embodiment, the silicone resin has a ratio of T units to D units (T/D) of from about 100/0 to about 5/95, from about 90/10 to about 15/85, or from about 80/20 to about 30/70.

The silicone resin is present in an amount of from about 3 wt. % to about 95 wt. %, from about 5 wt. % to about 90 wt. %, from about 20 wt. % to about 80 wt. %, or from about 30 wt. % to about 60 wt. %, or from about 40 wt. % to about 50 wt. % based on the total weight of the composition.

Some examples of suitable silicone resins that may be employed in the composition include, but are not limited to, silicone resins available from Momentive Performance Materials Inc. such as, but not limited to, those sold under the tradenames SR882M, TSR1452, TSR117, TSR127B, TSR144, SR355, CoatOSil M120XB, TSR165, TSR 160, XR31-B2230, XR31-B1410, XR31-B2733, XR31-B1763, XR31-B6667 and the like.

The hydrophilic silane is a silane or a hydrophilic silane oligomer comprising a hydrophilic functional group. The hydrophilic functional group is not particularly limited and can be selected as desired from a group that will impart hydrophilicity to the polymer. Examples of suitable hydrophilic groups include, but are not limited to, a polyalkylene glycol group, a sulfonate group, a phosphonate group, a carboxylate group, a carbohydrate group, a sugar group, a quaternary amine, and the like.

In one embodiment, the silane is a compound of the formula:

R⁹—Si(R¹⁰)_{f}(OR¹¹)_{3-f}; or

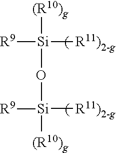

where R⁹ is a hydrophilic group, and R¹⁰ and R¹¹ are independently selected from a C1-C10 hydrocarbon; f is 0, 1, 2, or 3; and g is 0, 1, or 2.

In one embodiment, the hydrophilic group is a polyalkyelene glycol of the formula:

—R¹²—[O—R¹³-]_{g}OR¹⁴
where R¹² is a C2-C10 hydrocarbon;
R¹³ is a C2-C10 hydrocarbon;
R¹⁴ is H or a C1-C10 hydrocarbon; and
g is 1-20.

In one embodiment, the hydrophilic group is a quaternary amine group. A quaternary amine group can be selected from a group of the formula:

—N⁺(R¹⁵)(R¹⁶)(R¹⁷)

where R¹⁵, R¹⁶, and R¹⁷ are each independently selected from n alkyl (C1-C22), aryl, or a combination of chemical groups forming a ring structure and up to 2 of R¹⁵, R¹⁶, and R¹⁷ may be H. The quaternary amine group can be a salt with a counterion (X⁻). The counterion is not particularly limited and can be selected from, for example, Cl, Br, N(SO₂CF₃)₂, BF₄, OSO₂C₄F₉, OSO₂CF₃, OSOCH₃, and the like.

In one embodiment, the hydrophilic group is selected from a sugar. The sugar may be a C6 or C5 saccharide. Examples of sugar groups include, but are not limited to, glucose (e.g., D-glucose), manose, ribose, fructose, galactose, N-methyl glucosamine (e.g., (2R,3R,4R,5S)-6-(Methylamino) hexane-1,2,3,4,5-pentol), and the like. In one embodiment the sugar group is N-methyl glucosamine.

The silicone modified organic polymers may be formed by reacting the polyol, the silicone resin, and the hydrophilic silane in the presence of a catalyst. The catalyst can be selected from metal salts and chelates of Ti, Zn, Ge, Ga, Sn, Ca, Li and Sb. Other known catalysts may also be used for this step-growth polymerization. A few examples of the catalysts which may be employed in the above process include but are not limited to titanium alkoxides, such as tetramethyl, tetraethyl, tetra(n-propyl), tetraisopropyl and tetrabutyl titanates; dialkyl tin compounds, such as di-(n-butyl) tin dilaurate, di-(n-butyl) tin oxide, and di-(n-butyl) tin diacetate; acetate salts and sulfate salts of metals, such as magnesium, calcium, germanium, zinc, antimony, etc. In one embodiment the catalyst is titanium alkoxides. Examples of organo tin catalysts include, but are not limited to, dialkyltin dicarboxylates such as dibutyltin dilaurate and dibutyltin acetate, tertiary amines, the stannous salts of carboxylic acids such as stannous octoate and stannous acetate, and the like. In one embodiment, the catalyst is selected from titanium alkoxide. Other suitable catalysts include amine catalysts. Examples of amine catalysts include, but are not limited to, bis(2,2′-dimethylamino)ethyl etber, trimethylamine, triethylenediamine, 1,8-diazabicyclo[5.4.0]undec-7-ene, triethylamine, N-methylmorpholine, N,N-ethylmorpholine, N,N-dimethylbenzylamine, N,N-dimethylethanolamine, N,N,N′,N′-tetramethyl-1,3-butanediamine, pentamethyldipropylenetriamine, triethanolamine, triethylenediamine, 2-{[2-(2-dimethylaminoethoxy)ethyl]methylamino}ethanol, pyridine oxide, and the like. The catalyst level is employed in an effective amount to enable the copolymer formation and is not critical and is dependent on the catalyst that is used. Generally, the catalyst is used in concentration ranges of about 5 to about 5000 ppm, preferably is less than about 1000 ppm and most preferably about 20 to about 1000 ppm. The reaction can be carried out at temperatures of from about 40° C. to about 170° C., from about 50° C. to about 150° C., or from about 75° C. to about 125° C.

Without being bound to any particular theory, the silicone resin will generally be bound to the organic backbone. The hydrophilic groups may be bound to the organic backbone and the silicone resin segments or portions. In embodiments, the hydrophilic groups are bound to the T-units of the silicone resin portion.

The silicone modified organic polymer is dispersible in water. In embodiments, the silicone modified organic polymer is directly dispersible in water.

The silicone modified organic polymer can optionally be emulsified to provide a water born resin. Emulsification may comprise mixing the silicone modified organic polymer with a surfactant, thickener, and water. If necessary, the pH of the mixture is maintained or brought to about neutral by adding a base as needed.

The surfactant for emulsification can be selected as desired for a particular purpose or intended application. Suitable surfactants include, but are not limited to, silicone polyether, sodium lauryl sulfate, sodium laureth sulfate, ammonium lauryl sulfate, ammonium laureth sulfate, potassium lauryl sulfate, potassium laureth sulfate, triethylamine lauryl sulfate, thiethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride lauryl sarcosine, cocoyl sarcosine, ammonium cocoyl sulfate, sodium cocoyl sulfate, potassium cocoyl sulfate, triethanolamine cocoyl sulfate, monoethanolamine cocoyl sulfate, sodium tridecyl benzene sulfonate and sodium dodecyl benzene sulfonate.

Suitable thickeners for forming the emulsion include, but are not limited to, hydrophobically modified alkali swellable emulsions, hydrophobically ethoxylated urethane, hydrophobically modified polyether, organoclays, hydrogenated castor oils, fumed silicas, polyamides, polysaccharide thickeners, starch, modified starches, xanthan, gellan, carragenan, pullulan, cellulose, cellulose derivatives, polyacrylic acids, polyacrylates copolymers, polyacrylamides, pectins, clays, and the like. An exemplary thickeners are Carbopol materials.

The emulsion may have an average particle size of from about 0.1 micron to about 50 micron, from about 0.5 micron to about 30 micron, from about 0.75 micron to about 20 micron, from about 1 micron to about 15 micron, from about 2 micron to about 10 micron, or from about 4 micron to about 8 micron. The average particle size may be measured by dynamic light scattering (DLS). A Malvern Mastersizer 2000 (www.malvern.com) may be used for the measurement at 25° C.

The aqueous dispersion of the silicone modified organic polymer or an emulsion thereof can be added to a paint or coating composition. The paints and coatings for purposes of the current invention mean any liquid, liquefiable, or mastic composition, which converts to a solid film after application to a substrate. The paints and coatings may be solvent-based or water based. Examples of paints and coatings systems include, but are not limited to, alkyd based; emulsion/latex paints or acrylic paints; polyurethane emulsions; polyurethane dispersions; polyester emulsions; epoxy emulsions; polyester emulsions; high-solids paints with low volatile organic compound content; powder coatings; or radiation curable coatings.

The aqueous dispersion of the silicone modified organic polymer or an emulsion thereof can be present in the coating composition in an amount of from about 0.5 wt. % to about 70 wt. %, from about 15 wt. % to about 55 wt. %, or from about 20 wt. % to about 45 wt. % based on the weight of the coating composition.

Pigments may be used to contribute color or opacity, protect the substrate from UV light, increase hardness, decrease ductility, and/or adjust gloss level. The pigments may be synthetic or natural. Inorganic or organic pigments can be employed. Examples of pigments may include clays, calcium carbonate, mica, metal powder, silicas, talcs, calcined clays, blanc fixe, precipitated calcium carbonate, synthetic pyrogenic silicas, the like, or a combination thereof.

Examples of inorganic pigments may include, but are not limited to, aluminum pigments such as silicates of sodium and aluminum containing sulfur (ultramarine violet) and a complex naturally occurring pigment of sulfur-containing sodio-silicate (Na₈₋₁₀Al₆Si₆O₂₄S₂₋₄) (ultramarine); barium copper pigments such as Chinese purple (BaCuSi₂O₆) and dark blue (BaCu₂Si₂O₇), copper pigments such as a synthetic pigment of calcium copper silicate (CaCuSi₄O₁₀), cupric acetoarsenite (Cu(C₂H₃O₂)₂·3Cu(AsO₂)₂); barium pigments such as barium sulfate (BaSO₄); manganese pigments such as manganic ammonium pyrophosphate (NH₄MnP₂O₇); cobalt pigments such as cobalt stannate (CoO₃Sn), potassium cobaltinitrite (Na₃Co(NO₂)₆), cobalt chromite (CoCr₂O₄), cobalt titanate (Co₂TiO₄); iron pigments such as a synthetic pigment of ferric hexacyanoferrate (Fe₇(CN)₁₈), a naturally occurring clay of monohydrated ferric oxide (Fe₂O₃·H₂O), anhydrous Fe₂O₃; cadmium pigments such as cadmiumsulfide (CdS), cadmium sulfoselenide (Cd₂SSe), cadmium selenide (CdSe); chromium pigments such as chromic oxide (Cr₂O₃), a pigment of hydrated chromic oxide (Cr₂O₃·H₂O), natural pigment of plumbous chromate (PbCrO₄), a naturally occurring pigment mixture composed of lead (II) chromate and lead (II) oxide (PbCrO₄+PbO); arsenic pigments such as monoclinic arsenic sulfide (As₂S₃); lead pigments such as lead antimonite (Pb(SbO₃)₂, basic plumbous carbonate ((PbCO₃)₂·Pb(OH)₂); mercury pigments such as mercuric sulfide (HgS); carbon pigments such as carbon black; antimony pigments such as stibous oxide (Sb₂O₃); zinc pigments such as zinc oxide (ZnO) or zinc chromate (ZnCrO₄); titanium pigments such as nickel antimony titanium yellow rutile (NiO·Sb₂O₃·20TiO₂) or titanium dioxide (TiO₂); a complex sulfur-containing sodio-silicate (Na₅₋₁₀Al₆Si₆O₂₄S₂₋₄) containing lazurite known as ultramarine blue, or the like.

Examples of organic pigments may include, but are not limited to, diarylide aniline yellow pigment; benzimidazole yellow dyes; heterocyclic yellow dyes; disazo condensation yellow dyes such as arylide yellow, isoindoline yellow, methane yellow, tetrachloroisoindolinone yellow, azomethine yellow, quinophthalone yellow, or triazinyl yellow, naphthol orange, calrion red, benzimidazolone orange; phthalocyannine green dyes with chemical formula ranging from C₃₂H₃Cl₁₃CuN₈ to C₃₂HCl₁₅CuN₈, copper phthalocyannine; 8,18-dichloro-5,15-diethyl-5,15-dihydrodiindolo(3,2-b: 3′,2′-m)tri-phenodioxazine known as diooxazine violet, or the like.

In one embodiment, the pigments may be present in an amount of from about 0 wt. % to about 20 wt. %, from about 0.1 wt. % to about 10 wt. %, or from about 0.5 wt. % to about 5 wt. % based on the total weight of the coating composition.

Fillers may be used for thickening of the film, reinforcing the binder, giving the paint texture, and/or increasing the paint volume. The fillers may include diatomaceous earth, talc, lime, barytes such as barium sulfate, clay, kaolin clay, precipitated or ground calcium carbonate, chalk, limestone, marble, magnesium carbonate, dolomite, fine quartz, silicates, metal powder, the like, or a combination thereof.

In one embodiment, fillers may be present in an amount of from about 0 wt. % to about 90 wt. %, from about 0.1 wt. % to about 60 wt. %, or from about 0.1 wt. % to about 30 wt. % or from about 0.5 wt. % to about 10 wt. % based on the total weight of the coating composition.

Additives may serve a variety of functions such as to modify surface tension, flow and leveling properties, appearance, gloss, texturing, increase wet edge and/or antifreeze properties, improve pigment stability, control foaming and/or skinning, modify rheology, modify mar resistance, act as catalysts, driers, thickeners, stabilizers, emulsifiers, texturizers, adhesion promoters, UV stabilizers, corrosion inhibitors, texturizers, de-glossing agents, biocides, fungicides, insecticides, algaecides, the like, or a combination thereof.

Examples of additives may be silicone polyether copolymers, a dispersion of high molecular weight polysiloxane or polydimethylsiloxane and silicone surfactant as additives increasing mar resistance and providing or improving slip; ethylene oxide surfactants; silicone emulsions, fluorosilicone, organo-modified silicone copolymers as additives providing foam control; aminopropyltriethoxysilane, 3-methacryloxypropyltrimethoxysilane, cationic vinylbenzyl and amino-functional methoxy-silane, glycidoxypropyltrimethoxysilane, silanol-functional additives, aqueous solutions of amino-functional silicone polymers as adhesion promoters and pigment treatment additives; silane/siloxane blends as additives promoting water resistance; arylalkyl-modified silicone, silicone polyether copolymers as additives improving leveling and gloss; silicone elastomer particles with epoxy functionality improving abrasion resistance and adding a smooth, matter finish; silicone polyether copolymers as additives enhancing substrate wetting; 2,2′-(2,5-thiophenediyl)bis(5-tert-butylbenzoxazole) as an optical brightener; 2-[2-hydroxy-3,5-di-(1,1-dimethylbenzyl)]-2H-benzotriazole, 2-(2H-benzotriazole-2-yl)-4-methylphenyl as UV light absorbers; tris(2,4-di-tert-butylphenyl)phosphite, stearyl-3-(3′,5′-di-tert-butyl-4-hydroxyphenyl) propionate, 2,2′-methylenebis(4-methyl-6-tert-butylphenol) as stabilizers; tetrachloroizo phthalonitrile, 3-iodo-2-propynyl butyl carbamate, 2-n-octyl-4-isothiazolin-3-one, diiodomethyl-p-tolysulphone, N-(trimethylthio) phtalamine, 1,2-benzisothiazolin-3-one as biocides; 2-(4-thiazolyl(benzimidazole), dichloroctylisothiazolone as fungicide/algaecide; potassium sodium phosphate as a buffer; hydrophobic copolymer polyelectrolyte as a pigment dispersant; modified hydroxyethyl methyl cellulose, as a thickener; modified polyols as foam suppressors; ester alcohol as a coalescent; calcium carbonate as an extender; talc as an additive to provide pigment spacing, firmness, anti-cracking, and barrier properties; aqueous butyl acrylate-styrene copolymer for dispersion; and (N-(2-aminoethyl)-3-aminopropyltrimethoxysilane, and aqueous acetic acid as catalysts. Any other additive for interior and exterior paint is also contemplated.

The paint or coating may be applied to any surface as desired for a particular purpose or intended application. The paints and coatings may be any paint or coating suitable for interior and/or exterior use, such as coatings over masonry, plasters, cellulose, and the like. The paint or coating can be applied to surfaces such as, but not limited to, metal such as aluminum, wood, cement, brick, plastic, composites with or without prior coating with an adhesion primer. The paint or coating can be applied to the surfaces by any suitable means such as brushing, spraying, etc.

The following examples illustrate embodiments of materials in accordance with the disclosed technology. The examples are intended to illustrate aspects and embodiments of the disclosed technology, and are not intended to limit the claims or disclosure to such specific embodiments

### EXAMPLES

The viscosity was measured using a HAAKE RheoStress 600 rotational rheometer under controlled conditions at a temperature of 25° C. and a shear rate of 10 sec-1. A Kegel C20/1° TiiL plate was used as the measuring geometry for accurate shear stress and viscosity determination. The particle sizes of materials in examples 12 to 16 were measured using a Malvern Mastersizer. The materials were first diluted 100 times in Milli-Q (MQ) water to achieve a suitable concentration for measurement. The particle size distribution is determined through laser diffraction analysis.

### Synthesis Examples

Hydrophilic silicone modified polymers were prepared by the reaction of a polyester polyol, a silicone resin, and a hydrophilic silane. The polyester polyols are described in Table 1, and the silicone resins are described in Table 2:

TABLE 1
List of polyols

| | | % | | Viscosity | OH value | Acid value | M_{w} |
|---|---|---|---|---|---|---|---|
| Polyol | Type | solid | Solvent | (Pas) | (mg KOH/g) | (mg KOH/g) | (Da) |
| P1 | Polyester | 60 | Xylene/ | 1.2-2.5 | 55 | 2-10 | 4500 |
| | | | Solvesso 150 | | | | |
| P2 | Polyester | 70 | Solvesso 100 | 2.7-2.9 | 60-70 | 1-12 | 2600 |
| P3 | Polyester | 70 | Xylene/ | 3.1-3.2 | 110-120 | 6-8 | 2000 |
| | | | Solvesso 150 | | | | |
| P4 | Polyester | 79 | Solvesso 100/ | 5.4-5.5 | 130-150 | 1-5 | 2000 |
| | | | Acetone | | | | |
| P5 | Polypropylene | 100 | Nil | 0.4-0.5 | 40-60 | ≤0.08 | 1500 |
| | glycol | | | | | | |
| P6 | Polycarbonate | 100 | Nil | 0.065-0.12^{#} | 204-244 | — | 500 |

TABLE 2
List of Silicone resin

| Silicone | T/D | Ph/Me | OR | |
|---|---|---|---|---|
| resin | ratio | ratio | (wt %) | % solid |
| S1¹ | 33/67 | 67/33 | 15 | 100 |
| S2¹ | 72/22 | 22/78 | 39 | 100 |
| S3² | 72/28 | 66/34 | 4.5 | 100 |

¹OR = MeOH;
²OR= OH capped

The hydrophilic silicone employed were 2-[Methoxy(polyethyleneoxy)propyl]trimethoxysilane (H1) where the average chain length of polyethyleneoxy units are 6-8 and Dimethyloctadecyl[3-(trimethoxysilyl)propyl]ammonium chloride (H2).

### Synthesis Examples of Hydrophilic Silicone Modified Polymers (SMP)

Example 1: Hydrophilic silicone modified polyester is prepared as follows: A two-liter 3-necked flask was equipped with the following: (1) a thermometer, (2) a reflux condenser, (3) a positive nitrogen pressure system, and (4) a magnetic stirrer. 800 g of polyester polyol (P1), 112.5 g of silicone resin (S1) and 37.5 g of hydrophilic silane (H1) were charged to the flask, which was maintained at 120° C. using an oil bath, and the mixture was stirred under nitrogen blanket until the mixture reached 120° C. To this mixture, 0.5 mL of a Lewis catalyst (titanium isopropoxide) was added. The temperature was raised to 135° C. and stirred for another 5 hours under similar conditions to form a yellowish brown transparent liquid product. As per the method of synthesis, the liquid product was dispersible in water. The liquid product had a viscosity of 7.5 Pas. Water dispersibility was tested by mixing 1 part of hydrophilic SMP and 2 parts of water. The polymers were considered water dispersible where no layer separation was observed, and a homogenous mixture was obtained.

The process described above for Example 1 was used to make the silicone modified polymers with the hydrophilic silane of Examples 2 to 9 and 11 using the materials as described in Table 3. Comparative Example 1 (CE-1) is described in Table 3 and does not employ a hydrophilic silane as a reactant.

Example 10: Hydrophilic silicone modified polyurethane (P7) is prepared as follows: A two-liter 3-necked flask was equipped with the following: (1) a thermometer, (2) a reflux condenser, (3) a positive nitrogen pressure system, and (4) a magnetic stirrer. 23 g of 1,6-Diisocyanatohexane, 400 g of PPG2000, and 0.1 g of 1,1,1-Tris(hydroxymethyl) propane was charged to the flask, which was maintained at 70° C. using an oil bath. The reaction was continued up to 4 hours until the isocyanate was fully consumed. Isocyanate was monitored by the IR peak at 2250 cm-1 The reaction is confirmed to be completed when the peak at 2250 cm-1 disappeared.

The respective SMP is made in the same reactor using the same method as described in Example 1 using the ingredients listed in Table 3

TABLE 3
Synthesis of SMP

| Ingredients | | E1⁴ | E2 | E3 | E4 | E5 | E6 | E7 | E8 | E9 | E10 | E11 | CE-1⁵ |
|---|---|---|---|---|---|---|---|---|---|---|---|---|---|
| Polymer | | SMP- | SMP- | SMP- | SMP- | SMP- | SMP- | SMP- | SMP- | SMP- | SMP- | SMP- | SMP- |
| designation | | 1 | 2 | 3 | 4 | 5 | 6 | 7 | 8 | 9 | 10 | 11 | CE |
| Polyols³ | P1 | 80 | | | | | | | | | | | 80 |
| | P2 | | 80 | | | | | 45 | | | | | |
| | P3 | | | 80 | | | 65 | | | | | | |
| | P4 | | | | 80 | 62.5 | | | | | | 70 | |
| | P5 | | | | | | | | 80 | | | | |
| | P6 | | | | | | | | | 80 | | | |
| | P7 | | | | | | | | | | 80 | | |
| Silicone | S1 | 15 | | 15 | | 30 | | | | 15 | 15 | 22.5 | 15 |
| resin* | S2 | | 15 | | 15 | | 30 | | 15 | | | | |
| | S3 | | | | | | | 50 | | | | | |
| Hydrophilic | H1 | 5 | 5 | 5 | 5 | 7.5 | 5 | 5 | | 5 | 5 | | 0 |
| silane* | H2 | | | | | | | | 5 | | | 7.5 | |

| | | | | | | | | | | | | |
|---|---|---|---|---|---|---|---|---|---|---|---|---|
| Viscosity (Pas) | 2.8 | 2.1 | 2.6 | 23.9 | 3.5 | 3.3 | 2.1 | 22.6 | 2.2 | 1.1 | 59.6 | 1.0 |
| Water | Yes | Yes | Yes | Yes | Yes | Yes | Yes | Yes | Yes | Yes | Yes | No |
| dispersible | | | | | | | | | | | | |

³Content-% by weight,
⁴E-Examples;
⁵CE-Comparative Examples

From the examples, it is clear that the functionalization of silicone modified polymer though the hydrophilic silane is making it hydrophilic and directly water dispersible.

### Examples of Water Borne SMP Resins

The polymers of Examples 1 to 11 and CE-1 were evaluated for their ability to be dispersed in water to provide water borne resins, Examples 12-22 and Comparative Example 2 (CE-2) described in Table 4. 50 parts of synthesized SMP, 0.5 parts of sodium dodecyl sulfate (SDS), 0.5 parts of Carbopol thickener (ET 2050), and 49 parts of water were mixed using a Dispermat® disperser (available from VMA-Getzmann) at 500 rpm for 10 minutes at room temperature. The pH was adjusted to neutral by adding a base (diethanolamine) under mixing. The mixture was allowed to disperse in room temperature for 30 minutes at 4000 RPM. After mixing, the solid content was adjusted to about 50% by addition of water to obtain white liquid product. Table 4 shows that the polymers in accordance with the present technology having a hydrophilic silane are dispersible and stable in water. Stability of the aqueous polymer dispersion is assessed by keeping the sample in an oven at 50° C. for 4 weeks and monitoring viscosity, particle size distribution, and visual changes at regular time intervals. This method allows for the assessment of material degradation or changes in properties over time under accelerated conditions.

TABLE 4
Water borne SMP-Properties

| | E-12 | E-13 | E-14 | E-15 | E-16 | E-17 | E-18 | E-19 | E-20 | E-21 | E-22 | CE-2 |
|---|---|---|---|---|---|---|---|---|---|---|---|---|
| | SMP- | SMP- | SMP- | SMP- | SMP- | SMP- | SMP- | SMP- | SMP- | SMP- | SMP- | SMP- |
| Polymer | 1 | 2 | 3 | 4 | 5 | 6 | 7 | 8 | 9 | 10 | 11 | 6 |
| Particle | 2.3 | 2.3 | 1.4 | 2.2 | 1.08 | 3.3 | 5.5 | 6.3 | 12.3 | 26.3 | 6.3 | No |
| size | | | | | | | | | | | | dispersion/ |
| (μM) | | | | | | | | | | | | emulsion |
| Viscosity | 0.95-1.15 | 1.5-1.6 | 2.0-2.1 | 2.3-2.4 | 0.95-1.2 | 3.3-3.6 | | | | | | NA |
| (Pas) | | | | | | | | | | | | |
| Stability | Yes | Yes | Yes | Yes | Yes | Yes | | | | | | NA |
| @50C | | | | | | | | | | | | |

The hydrophilic silane modification of the SMP enables an easy process to make an aqueous dispersion/emulsion without using a complex emulsion process using surfactants. Moreover, the hydrophilic nature of the new polymers reported here may enable its direct addition to aqueous formulation as binder to make water borne paint composition.

### Performance Testing

A method for evaluating the coating properties of waterborne resins is disclosed. The coating material is applied to an aluminum panel (A-36 from Q-lab) using a BYK film applicator to achieve a film thickness of 60 μm. The coated panel is then cured at 280° C. for 20 minutes. The coated film is subsequently tested for pencil hardness and adhesion using the crosscut method. This method allows for assessing the mechanical properties and durability of waterborne resin coatings.

The results were captured in Table 5.

TABLE 5
Performance testing

| | Pencil | Adhesion |
|---|---|---|
| Material | Hardness | (Cross cut) |
| E-12 | F-H | Good |
| E-13 | F-H | Good |
| E-16 | H | Good |
| E-17 | 2H | Good |
| E-18 | 3H | Good |

As summarized in table 5, the coatings made with the examples show good hardness value and very adhesion values.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a silicone modified organic polymer, dispersions and emulsions comprising the same, and coating compositions comprising the same. Modifications may occur to those skilled in the art and to those who may make and use the invention. The disclosed embodiments are merely for illustrative purposes and not intended to limit the scope of the invention or the subject matter set forth in the claims.

What is claimed is:

1. A silicone modified organic polymer comprising a reaction product of:
an organic polyol;
a silicone resin; and
a hydrophilic silane or an oligomer thereof;
wherein the silicone resin is an organopolysiloxane of the formula:
MDTQ
where
M is R¹R²R³SiO^{1/2}
D is R⁴R⁵SiO_{2/2}
T is R⁶SiO_{3/2};
Q is SiO_{4/2}; and
where R¹, R², R³, R⁴, R⁵, and R⁶ are independently selected from a monovalent hydrocarbon radical, OR⁷ or a divalent hydrocarbon radical, OR⁸O, where R⁷ is independently selected from H or a C1-C10 hydrocarbon radical and R⁸ is independently selected from C1-C10 divalent hydrocarbon radical.

2. The silicone modified organic polymer of claim 1, wherein the hydrophilic silane is of the formula:
R⁹—Si(R¹⁰)_{f}(OR¹¹)_{3-f}; 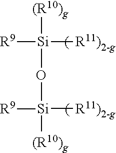
or a mixture thereof;
where R⁹ is a hydrophilic group, and R¹⁰ and R¹¹ are independently selected from a C1-C10 hydrocarbon; f is 0, 1, 2, or 3; and g is 0, 1, or 2.

3. The silicone modified organic polymer of claim 2, wherein R⁹ is selected from a polyalkylene glycol group, a sulfonate group, a phosphonate group, a carboxylate group, a carbohydrate group, a sugar group, and a quaternary amine group.

4. The silicone modified organic polymer of claim 2, wherein R⁹ is a polyalkylene group of the formula:
—R¹²—[O—R¹³-]_{g}OR¹⁴
where R¹² is a C2-C10 hydrocarbon;
R¹³ is a C2-C10 hydrocarbon;
R¹⁴ is H or a C1-C10 hydrocarbon; and
g is 1-20.

5. The silicone modified organic polymer of claim 2, wherein the hydrophilic group is a quaternary amine group of the formula:
—N+(R¹⁵)(R¹⁶)(R¹⁷)
where R¹⁵, R¹⁶, and R¹⁷ are each independently selected from n alkyl (C1-C22), aryl, or a combination of chemical groups forming a ring structure and up to 2 of R¹⁵, R¹⁶, and R¹⁷ may be H.

6. The silicone modified organic polymer of claim 1, wherein the silicone resin comprises a OR⁷ group and/or an OR⁸O in an amount of from about 0.1 wt. % to about 50 wt. %, based on the weight of the polyorganosiloxane.

7. The silicone modified organic polymer of claim 1, wherein the silicone resin is a DT type resin comprising from about 0.5 wt. % to about 70 wt. % of the D unit, and from about 30 wt. % to about 99.5 wt. % of a T unit based on the total weight of the silicone resin.

8. The silicone modified organic polymer of claim 1, wherein the organic polyol is selected from the group consisting of a polyester polyol, a polyether polyol, a polyurethane polyol, a poly(urea)urethane polyol, a polyacrylate polyol, a polycarbonate polyol, and a polyamide polyol.

9. The silicone modified organic polymer of claim 1, wherein the organic polyol is a polyester polyol.

10. The silicone modified organic polymer of claim 1, wherein the organic polyol is a polyether polyol.

11. The silicone modified organic polymer of claim 1, wherein the organic polyol is a polycarbonate polyol.

12. The silicone modified organic polymer of claim 1, wherein the organic polyol has a OH value of from about 3 to about 400 KOH/g

13. The silicone modified organic polymer of claim 1, wherein the organic polyol is present in the composition in an amount of from about 3 wt. % to about 95 wt. % based on the weight of the composition.

14. The silicone modified organic polymer of claim 1, wherein the silicone resin is present in the composition in an amount of from about 3 wt. % to about 95 wt. % based on the weight of the composition.

15. The silicone modified organic polymer of claim 1, wherein the hydrophilic silane is present in the composition in an amount of from about 1 wt. % to about 40 wt. % based on the weight of the composition.

16. The silicone modified organic polymer of claim 1, wherein the silicone modified organic polymer is hydrophilic.

17. An aqueous dispersion comprising the silicone modified organic polymer of claim 1 and water.

18. The aqueous dispersion of claim 17 having an average particle size of from about 0.1 micron to about 50 micron.

19. The aqueous dispersion of claim 17 comprising a surfactant.

20. The aqueous dispersion of claim 19 further comprising a base.

21. A paint, coating, adhesive or sealant composition comprising the aqueous dispersion of claim 17.

22. An article made using composition of claim 21.

23. A process for preparing a silicone modified organic polymer of claim 1 comprising reacting a mixture of the organic polyol, the silicone resin, and the hydrophilic silane in the presence of a catalyst.

24. The process of claim 23, wherein the reaction is conducted at a temperature of from about 40° C. to about 170° C.

25. A process for forming an aqueous dispersion comprising mixing the silicone modified organic polymer of claim 1 in water.

26. A composition comprising a silicone modified organic polymer and water, the silicone modified organic polymer comprising a reaction product of:
an organic polyol;
a silicone resin; and
a hydrophilic silane or an oligomer thereof;
wherein the silicone resin is an organopolysiloxane of the formula:
MDTQ
where
M is R¹R²R³SiO^{1/2}
D is R⁴R⁵SiO_{2/2}
T is R⁶SiO_{3/2};
Q is SiO_{4/2}; and
where R¹, R², R³, R⁴, R⁵, and R⁶ are independently selected from a monovalent hydrocarbon radical, OR⁷ or a divalent hydrocarbon radical, OR⁸O, where R⁷ is independently selected from H or a C1-C10 hydrocarbon radical and R⁸ is independently selected from C1-C10 divalent hydrocarbon radical.
